(19) United States
(12) Patent Application Publication
(10) Pub. No.: US 2026/0071060 A1
(43) Pub. Date: Mar. 12, 2026

(54) RUBBER COMPOSITION AND TIRE

(71) Applicant: Toyo Tire Corporation, Itami-shi (JP)

(72) Inventor: Yosuke Nakaji, Itami-shi (JP)

(73) Assignee: Toyo Tire Corporation, Itami-shi (JP)

(21) Appl. No.: 19/308,453

(22) Filed: Aug. 25, 2025

(30) Foreign Application Priority Data
Sep. 10, 2024 (JP) 2024-156639

(51) Int. Cl. C08L 9/06; B60C 1/00; C08K 3/04; C08K 3/36; C08K 5/01; C08K 5/103

(52) U.S. Cl. CPC C08L 9/06; B60C 1/00; C08K 3/36; C08K 5/01; C08K 5/103; C08K 3/04; C08L 2205/025

(57) ABSTRACT

A rubber composition according to an embodiment contains a diene rubber, silica, a sorbitan fatty acid ester having an HLB value of 3.5 or more and 5.0 or less, and a mineral oil that is an optional component. The mineral oil (including an extender oil) is contained such that the mass ratio of the mineral oil to the sorbitan fatty acid ester is 0 or more and 9 or less.

### BACKGROUND OF THE INVENTION

### 1. Field of the Invention

The present invention relates to a rubber composition and a tire using the same.

### 2. Description of Related Art

As plasticizers to be incorporated when making a rubber composition, generally, mineral oils such as aromatic oils, naphthenic oils, and paraffinic oils are used.

It has also been considered to use vegetable oils in place of mineral oils. For example, JP2021-021064A discloses that in a rubber composition containing a specific solution-polymerized styrene butadiene rubber, silica, and a plasticizer including a hydrocarbon resin and an oil, a vegetable oil such as sunflower oil or soybean oil is used as the oil.

Meanwhile, it is known that a surfactant is incorporated as an additive into a rubber composition. For example, JP2020-132860A discloses a rubber composition for a tread excellent in wet grip performance and abrasion resistance, which contains a rubber component, a surfactant such as a sorbitan fatty acid ester, silica, and at least one plasticizer component selected from the group consisting of a liquid plasticizer and a resin.

JP6053763B discloses a rubber composition that exhibits excellent abrasion resistance without deterioration in the performance such as rolling resistance, which is obtained by kneading a rubber component with hydrous silicic acid modified with 0.05 to 1.0 part by mass of a surfactant per 100 parts by mass of the hydrous silicic acid.

### SUMMARY OF THE INVENTION

Currently, from the viewpoint of resource conservation and the like, there is a demand for the development of a rubber composition in which the mineral oil incorporated as a plasticizer is partially or completely replaced with a new raw material. Here, when considering raw materials to replace mineral oils, the obtained rubber composition is expected to have excellent properties equivalent to or better than those of conventional rubber compositions. However, in the case where the mineral oil is replaced with a vegetable oil, for example, the physical properties of the resulting vulcanized rubber may be inferior.

In view of the above points, an object of an embodiment of the invention is to provide a rubber composition for a tire, which contains a raw material capable of partially or completely replacing a mineral oil.

The invention includes the following embodiments.
[1] A rubber composition for a tire, including a diene rubber, silica, a sorbitan fatty acid ester, and a mineral oil that is an optional component, in which the sorbitan fatty acid ester has an HLB value of 3.5 or more and 5.0 or less, and a mass ratio of the mineral oil to the sorbitan fatty acid ester is 0 or more and 9 or less.
[2] The rubber composition for a tire according to [1], in which the diene rubber includes a modified styrene butadiene rubber.
[3] The rubber composition for a tire according to [1] or [2], in which 100 parts by mass of the diene rubber includes 20 to 60 parts by mass of an unmodified styrene butadiene rubber and 40 to 80 parts by mass of a modified styrene butadiene rubber.
[4] The rubber composition for a tire according to any one of [1] to [3], in which the sorbitan fatty acid ester includes at least one selected from the group consisting of sorbitan monooleate, sorbitan monostearate, sorbitan monoisostearate, sorbitan sesquioleate, sorbitan sesquistearate, sorbitan sesquiisostearate, sorbitan dioleate, sorbitan distearate, and sorbitan diisostearate.
[5] The rubber composition for a tire according to any one of [1] to [4], in which the sorbitan fatty acid ester includes a plant-derived sorbitan fatty acid ester.
[6] The rubber composition for a tire according to any one of [1] to [5], in which a total content of the sorbitan fatty acid ester and the mineral oil is 10 to 100 parts by mass per 100 parts by mass of the diene rubber.
[7] A tire having a rubber portion made using the rubber composition according to any one of [1] to [6].

According to an embodiment of the invention, a rubber composition for a tire, which contains a raw material capable of partially or completely replacing a mineral oil, can be provided.

### DESCRIPTION OF EMBODIMENTS

The present inventor has conducted extensive research on raw materials that function as replacements for mineral oils without impairing properties as a vulcanized rubber. As a result, the present inventor has focused on a sorbitan fatty acid ester, which is a type of nonionic surfactant. Then, the present inventor has found that when a sorbitan fatty acid ester having an HLB value of 3.5 or more and 5.0 or less is used to partially or completely replace a mineral oil, the physical properties, such as elastic modulus, of the resulting vulcanized rubber improve.

A rubber composition according to this embodiment contains a diene rubber as a rubber component, silica as a reinforcing filler, and a sorbitan fatty acid ester and a mineral oil as a plasticizer. Here, the mineral oil is an optional component, and therefore the rubber composition according to this embodiment may or may not contain a mineral oil.

In this embodiment, a diene rubber refers to a rubber with a repeating unit corresponding to a diene monomer having a conjugated double bond, and contains a carbon-carbon double bond in the polymer backbone. Specific examples of diene rubbers include various diene rubbers commonly used in rubber compositions, such as natural rubbers (NR), synthetic isoprene rubbers (IR), polybutadiene rubbers (BR), styrene butadiene rubbers (SBR), nitrile rubbers (NBR), chloroprene rubbers (CR), styrene-isoprene copolymer rubbers, butadiene-isoprene copolymer rubbers, and styrene-isoprene-butadiene copolymer rubbers. As these diene rubbers, the concept thereof also encompasses those modified at the ends or in the backbone as necessary and those reformed to impart desired properties. These diene rubbers may be used alone, and it is also possible to use two or more kinds together.

As the diene rubber, an oil-extended diene rubber may also be used. As extender oils used for oil-extending a diene rubber, mineral oils such as aromatic oils, naphthenic oils, and paraffinic oils can be mentioned, for example.

In one embodiment, the diene rubber may include a styrene butadiene rubber. The styrene butadiene rubber may be a solution-polymerized styrene butadiene rubber (SSBR) or an emulsion-polymerized styrene butadiene rubber (ESBR). In addition, the styrene butadiene rubber may be a modified styrene butadiene rubber (modified SBR) or an unmodified styrene butadiene rubber (unmodified SBR).

Preferably, in one embodiment, the diene rubber includes a modified styrene butadiene rubber (modified SBR). As the modified SBR, one that has a functional group introduced into its end and/or backbone and thus has been modified with the functional group is used. The functional group preferably contains an oxygen atom and/or a nitrogen atom and, for example, at least one selected from the group consisting of an amino group, a hydroxy group, an alkoxy group, an alkoxysilyl group, an epoxy group, and a carboxy group can be mentioned.

The modified SBR may be a modified solution-polymerized styrene butadiene rubber (modified SSBR), a modified emulsion-polymerized styrene butadiene rubber (modified ESBR), or a combination thereof. The amount of modified SBR in 100 parts by mass of the diene rubber is not particularly limited, and may be, for example, 30 parts by mass or more, 40 parts by mass or more, or 50 parts by mass or more.

In one embodiment, the diene rubber may be a combination of an unmodified SBR and a modified SBR, and it is preferable to use an unmodified ESBR and a modified SSBR. For example, 100 parts by mass of the diene rubber may include 20 to 60 parts by mass, more preferably 30 to 50 parts by mass, of an unmodified SBR (preferably an unmodified ESBR) and 40 to 80 parts by mass, more preferably 50 to 70 parts by mass, of a modified SBR (preferably a modified SSBR).

In this embodiment, examples of silica include wet silica and dry silica. It is preferable to use wet silica such as precipitated silica or gelled silica.

The amount of silica per 100 parts by mass of the diene rubber is preferably 30 to 150 parts by mass, more preferably 50 to 120 parts by mass, still more preferably 60 to 110 parts by mass, and yet more preferably 70 to 100 parts by mass.

The rubber composition according to this embodiment incorporates a sorbitan fatty acid ester having an HLB value of 3.5 or more and 5.0 or less. A sorbitan fatty acid ester having such an HLB value functions as a replacement for a mineral oil, and a rubber composition having equal or better vulcanized rubber physical properties compared to the case of using a mineral oil can be obtained. In detail, when the HLB value is 5.0 or less, it is possible to provide a vulcanized rubber with an improved elastic modulus (300% modulus), and the steering stability in a tire can be improved. When the HLB value is 3.5 or more, it is possible to provide a vulcanized rubber with an improved elongation at break, and the abrasion resistance in a tire can be expected to improve. The HLB value of the sorbitan fatty acid ester is preferably 3.7 to 4.7, and more preferably 4.0 to 4.5.

The sorbitan fatty acid ester may be a sorbitan mono-fatty acid ester, a sorbitan sesqui-fatty acid ester, a sorbitan di-fatty acid ester, or a sorbitan tri-fatty acid ester. In addition, it may be a solid or a liquid at room temperature (25° C.). Specific examples thereof include sorbitan monooleate, sorbitan monostearate, sorbitan monoisostearate, sorbitan sesquioleate, sorbitan sesquistearate, sorbitan sesquiisostearate, sorbitan dioleate, sorbitan distearate, and sorbitan diisostearate. They may be used alone, and it is also possible to use two or more kinds together.

Here, the HLB value (hydrophilic-lipophilic balance) of a sorbitan fatty acid ester indicates the molecular weight of the hydrophilic group portion in the total molecular weight of the sorbitan fatty acid ester, and is determined by Griffin's formula (HLB value=molecular weight of hydrophilic group portion×20/total molecular weight).

In this embodiment, in the case where two or more kinds of sorbitan fatty acid esters are used together, the HLB value of a sorbitan fatty acid ester refers to the HLB value of a mixture of the several kinds of sorbitan fatty acid esters (hereinafter referred to as “mixed sorbitan fatty acid ester”). Therefore, the HLB value of the mixed sorbitan fatty acid ester should be 3.5 or more and 5.0 or less.

Here, as shown in the following formula, the HLB value of a mixed sorbitan fatty acid ester is determined by arithmetically averaging the HLB values of the individual sorbitan fatty acid esters based on their blending ratio.

$$HLB value of mixed sorbitan fatty acid ester = \sum ( {HLB}_{X} \times {W}_{X} ) \sum {W}_{X}$$

HLB_{X} represents the HLB value of sorbitan fatty acid ester X.

W_{X} represents the mass (g) of sorbitan fatty acid ester X having the value of HLB_{X}.

As the sorbitan fatty acid ester, from the viewpoint of reducing the use of petroleum-derived resources, a plant-derived sorbitan fatty acid ester is preferably used. A plant-derived sorbitan fatty acid ester can be synthesized from plant-derived sorbitol and/or sorbitan and a plant-derived fatty acid.

As specific examples of sorbitan fatty acid esters as described above, for example, “RHEODOL SP-010V”, “RHEODOL AO-10V”, “RHEODOL SP-S10V”, “RHEODOL AS-10V”, “RHEODOL AO-15V”, and “RHEODOL SP-S20” manufactured and sold by Kao Corporation, etc., can be used.

The rubber composition according to this embodiment may optionally contain a mineral oil. As mineral oils, for example, aromatic oils, naphthenic oils, and paraffinic oils can be mentioned. They may be used alone, and it is also possible to use two or more kinds together.

In this embodiment, the mineral oil is contained such that the mass ratio of the mineral oil to the sorbitan fatty acid ester (mineral oil/sorbitan fatty acid ester) is 0 or more and 9 or less. Incidentally, in the case where an oil-extended rubber is used as the diene rubber, the mass of the mineral oil also includes the mass of the mineral oil contained in the oil-extended rubber (extender oil). The mass ratio (mineral oil/sorbitan fatty acid ester) is preferably 0 to 5, more preferably 0 to 3, and still more preferably 0 to 2, and may also be 0.5 to 2.

The content of the plasticizer as a whole (the sum of the sorbitan fatty acid ester and the mineral oil) in the rubber composition is not particularly limited, and may be, for example, 10 to 100 parts by mass, 15 to 50 parts by mass, or 20 to 40 parts by mass per 100 parts by mass of the diene rubber. The content of the sorbitan fatty acid ester is not particularly limited, and may be, for example, 1 to 50 parts by mass, 5 to 40 parts by mass, or 10 to 30 parts by mass per 100 parts by mass of the diene rubber. The content of the mineral oil is not particularly limited, and may be, for example, 0 to 50 parts by mass, 1 to 40 parts by mass, 5 to 30 parts by mass, or 10 to 20 parts by mass per 100 parts by mass of the diene rubber.

In addition to the above components, the rubber composition according to this embodiment can also incorporate various additives that are generally used in rubber compositions, such as carbon black, silane coupling agents, stearic acid, zinc oxide, waxes, antioxidants, vulcanizing agents, and vulcanization accelerators.

The carbon black content is not particularly limited, but is preferably 0 to 30 parts by mass, more preferably 0 to 20 parts by mass, and still more preferably 3 to 15 parts by mass, or may also be 3 to 10 parts by mass, per 100 parts by mass of the diene rubber.

As silane coupling agents, for example, a sulfide silane coupling agent, a mercapto silane coupling agent, and a thioester group-containing silane coupling agent can be mentioned. The silane coupling agent content is not particularly limited, and may be, for example, 5 to 20 parts by mass, or 5 to 15 parts by mass, per 100 parts by mass of silica.

The stearic acid content is not particularly limited, and may be, for example, 0 to 10 parts by mass, 0.5 to 5 parts by mass, or 1 to 4 parts by mass per 100 parts by mass of the diene rubber.

The zinc oxide content is not particularly limited, and may be, for example, 0 to 10 parts by mass, 0.5 to 5 parts by mass, or 1 to 4 parts by mass per 100 parts by mass of the diene rubber.

The wax content is not particularly limited, and may be, for example, 0 to 10 parts by mass, 0.5 to 5 parts by mass, or 1 to 4 parts by mass per 100 parts by mass of the diene rubber.

As antioxidants, for example, amine-ketone-based, aromatic secondary amine-based, monophenol-based, bisphenol-based, benzimidazole-based, and like various antioxidants can be mentioned. Any one of them, or a combination of two or more, can be used. The antioxidant content is not particularly limited, and may be, for example, 0 to 10 parts by mass, 0.5 to 5 parts by mass, or 1 to 4 parts by mass per 100 parts by mass of the diene rubber.

Sulfur is preferably used as a vulcanizing agent. The vulcanizing agent content is not particularly limited, and may be, for example, 0.1 to 10 parts by mass, 0.5 to 5 parts by mass, or 1 to 3 parts by mass per 100 parts by mass of the diene rubber.

As vulcanization accelerators, for example, sulfenamide-based, guanidine-based, thiuram-based, thiazole-based, and like various vulcanization accelerators can be mentioned. Any one of them, or a combination of two or more, can be used. The vulcanization accelerator content is not particularly limited, and may be, for example, 0.1 to 10 parts by mass, 1 to 7 parts by mass, or 2 to 5 parts by mass per 100 parts by mass of the diene rubber.

The rubber composition according to this embodiment can be made by kneading in the usual manner using a commonly used mixing machine, such as a Banbury mixer, a kneader, or a roll. That is, for example, in the first mixing stage, additives other than a vulcanizing agent and a vulcanization accelerator are added to a diene rubber and mixed. Next, in the final mixing stage, a vulcanizing agent and a vulcanization accelerator are added to the obtained mixture, whereby a rubber composition can be made. Prior to the final mixing stage, the mixture obtained in the first mixing stage may be kneaded again.

The rubber composition according to this embodiment can be used in various sections of a tire, such as treads, sidewalls, and bead parts of pneumatic tires of various sizes for various applications, including tires for passenger cars, large-size tires for trucks and buses, and the like. Use in the tread or sidewall of a tire is preferable. That is, a tire according to one embodiment has a rubber portion made using the rubber composition described above.

In one embodiment, the method for producing a tire including a rubber portion made using the rubber composition described above is not particularly limited. For example, the rubber composition is molded into a predetermined shape by extrusion in the usual manner to give an unvulcanized rubber member (e.g., tread rubber, sidewall rubber, etc.). The rubber member is combined with other tire members to make an unvulcanized tire (green tire). Subsequently, vulcanization molding is performed at 140 to 180° C., for example, whereby a tire can be produced.

### EXAMPLES

Hereinafter, examples will be shown, but the invention is not limited to these examples.

Details of the raw materials used in the examples and comparative examples are as follows.
SBR-1: Unmodified ESBR, “SBR 1502” manufactured by ENEOS Materials Corporation
SBR-2: SSBR terminally modified with alkoxysilyl and amino groups, “HPR 350” manufactured by ENEOS Materials Corporation
Silica: “Nipsil AQ” manufactured by Tosoh Silica Corporation
Carbon black: HAF, “N339 SEAST KH” manufactured by Tokai Carbon Co., Ltd.
Aromatic oil: “PROCESS NC140” manufactured by ENEOS Corporation
Vegetable oil: “Soybean Oil” manufactured by Nacalai Tesque, Inc.
Sorbitan fatty acid ester-1: Sorbitan trioleate, “RHEODOL SP-030V” manufactured by Kao Corporation (HLB value=1.8)
Sorbitan fatty acid ester-2: Sorbitan monolaurate, “RHEODOL SP-L10” manufactured by Kao Corporation (HLB value=8.6)
Sorbitan fatty acid ester-3: Sorbitan sesquioleate, “RHEODOL AO-15V” manufactured by Kao Corporation (HLB value=3.7)
Sorbitan fatty acid ester-4: Sorbitan monooleate, “RHEODOL SP-010V” manufactured by Kao Corporation (HLB value=4.3)
Sorbitan fatty acid ester-5: Sorbitan monostearate, “RHEODOL SP-S10V” manufactured by Kao Corporation (HLB value=4.7)
Silane coupling agent: “Si69” manufactured by Evonik
Stearic acid: “LUNAC S-20” manufactured by Kao Corporation
Zinc oxide: “Zinc Oxide, Type 2” manufactured by Mitsui Mining & Smelting Co., Ltd.
Wax: “OZOACE 0355” manufactured by Nippon Seiro Co., Ltd.
Antioxidant-1: N-(1,3-dimethylbutyl)-N′-phenyl-p-phenylenediamine, “NOCRAC 6C” manufactured by Ouchi Shinko Chemical Industrial Co., Ltd.
Antioxidant-2: Poly(2,2,4-trimethyl-1,2-dihydroquinoline), “ANTAGE RD” manufactured by Kawaguchi Chemical Industry Co., Ltd.
Vulcanizing agent: “Powder Sulfur” manufactured by Tsurumi Chemical Industry Co., Ltd.
Vulcanization accelerator-1: “SOXINOL CZ” manufactured by Sumitomo Chemical Co., Ltd.
Vulcanization accelerator-2: Diphenyl guanidine, “NOCCELER D” manufactured by Ouchi Shinko Chemical Industrial Co., Ltd.

The evaluation methods in the examples and comparative examples are as follows.

### (1) 300% Modulus

In accordance with JIS K6251:2017, a tensile test (No. 3 dumbbell shape) was performed to measure the 300% modulus. The values of the comparative examples and examples are each shown as an index taking the value of Comparative Example 1 in Table 1, and the value of Comparative Example 5 in Table 2, as 100. A larger index indicates a higher 300% modulus. The higher the 300% modulus, the higher the tire rigidity, indicating better steering stability.

### (2) Elongation at Break

In accordance with JIS K6251:2017, a tensile test (No. 3 dumbbell shape) was performed to measure the elongation at break (elongation at the time of breakage) (%). The values of the comparative examples and examples are each shown as an index taking the value of Comparative Example 1 as 100. A larger index indicates higher elongation at break.

### (3) Tear Strength

In accordance with JIS K6252-1:2015, a tensile test (crescent shape) was performed to measure the tear strength. The values of the comparative examples and examples are each shown as an index taking the value of Comparative Example 5 as 100. A larger index indicates higher tear strength. High tear strength means that the rubber composition has high chipping resistance when used in a tire tread.

### [First Experiment Example]

According to the formulation (parts by mass) shown in Table 1 below, a rubber composition was prepared using a Banbury mixer. In detail, first, in the first mixing stage, all ingredients excluding a vulcanizing agent and a vulcanization accelerator were added to a diene rubber together with silica, a sorbitan fatty acid ester, and a mineral oil as an optional component, and kneaded (discharge temperature=160° C.). The discharged rubber composition was fed to a Banbury mixer and kneaded again, and then discharged (discharge temperature=160° C.). Next, in the final mixing stage, a vulcanizing agent and a vulcanization accelerator were added to the obtained kneaded product and kneaded (discharge temperature=100° C.) to prepare a rubber composition.

Each obtained rubber composition was vulcanized at 160° C. for 20 minutes to make a rubber sample, and the 300% modulus and the elongation at break were evaluated.

The results are as shown in Table 1 below. In Table 1, the amount of each component incorporated (parts by mass) is uniform, and only the kind of raw material used as a plasticizer is changed. Comparative Example 1 is an example where an aromatic oil was used as a plasticizer, and Comparative Example 2 is an example where a vegetable oil was used as a plasticizer. In Comparative Example 2, the elongation at break was superior as compared to Comparative Example 1, but the 300% modulus was inferior.

Comparative Example 3 is an example where a sorbitan fatty acid ester having an HLB value below the lower limit was used as a plasticizer. In Comparative Example 3, the 300% modulus significantly improved as compared to Comparative Example 1, but the elongation at break significantly decreased.

Comparative Example 4 is an example where a sorbitan fatty acid ester having an HLB value above the upper limit was used as a plasticizer. In Comparative Example 4, the elongation at break was superior as compared to Comparative Example 1, but the 300% modulus was inferior.

Examples 1 to 3 are examples where a sorbitan fatty acid ester having an HLB value within the specified range was used as a plasticizer. In all of the examples, as compared to Comparative Example 1, both the 300% modulus and the elongation at break improved.

TABLE 1

| | Comp. | Comp. | Comp. | Comp. | | | |
|---|---|---|---|---|---|---|---|
| | Ex. 1 | Ex. 2 | Ex. 3 | Ex. 4 | Ex. 1 | Ex. 2 | Ex. 3 |
| Formulation (parts by mass) | | | | | | | |
| SBR-1 | 40 | 40 | 40 | 40 | 40 | 40 | 40 |
| SBR-2 | 60 | 60 | 60 | 60 | 60 | 60 | 60 |
| Silica | 85 | 85 | 85 | 85 | 85 | 85 | 85 |
| Carbon black | 5 | 5 | 5 | 5 | 5 | 5 | 5 |
| Aromatic oil | 27 | | | | | | |
| Vegetable oil | | 27 | | | | | |
| Sorbitan fatty acid ester-1 | | | 27 | | | | |
| Sorbitan fatty acid ester-2 | | | | 27 | | | |
| Sorbitan fatty acid ester-3 | | | | | 27 | | |
| Sorbitan fatty acid ester-4 | | | | | | 27 | |
| Sorbitan fatty acid ester-5 | | | | | | | 27 |
| Silane coupling agent | 7 | 7 | 7 | 7 | 7 | 7 | 7 |
| Stearic acid | 2 | 2 | 2 | 2 | 2 | 2 | 2 |
| Zinc oxide | 2 | 2 | 2 | 2 | 2 | 2 | 2 |
| Wax | 2 | 2 | 2 | 2 | 2 | 2 | 2 |
| Antioxidant-1 | 2 | 2 | 2 | 2 | 2 | 2 | 2 |
| Antioxidant-2 | 1 | 1 | 1 | 1 | 1 | 1 | 1 |
| Vulcanizing agent | 2 | 2 | 2 | 2 | 2 | 2 | 2 |
| Vulcanization accelerator- | 2 | 2 | 2 | 2 | 2 | 2 | 2 |
| 1 | | | | | | | |
| Vulcanization accelerator- | 2 | 2 | 2 | 2 | 2 | 2 | 2 |
| 2 | | | | | | | |
| Evaluation (index) | | | | | | | |
| 300% Modulus | 100 | 82 | 137 | 86 | 104 | 110 | 106 |
| Elongation at break | 100 | 109 | 75 | 116 | 103 | 109 | 104 |

### Second Experiment Example

Rubber compositions of Comparative Example 5 and Examples 4 to 8 were prepared in the same manner as in the first experiment example, except for following the formulation (parts by mass) shown in Table 2 below. Each obtained rubber composition was vulcanized at 160° C. for 20 minutes to make a rubber sample, and the 300% modulus and the tear strength were evaluated.

The results are as shown in Table 2 below. Incidentally, Plasticizer Component Mass Ratio in the table means the mass ratio of the aromatic oil to the sorbitan fatty acid ester (hereinafter sometimes simply referred to as “plasticizer component mass ratio”). In Table 2, only the plasticizer component mass ratio was changed, and the obtained rubber compositions were evaluated.

Comparative Example 5 is an example where only an aromatic oil was used as a plasticizer, and the formulation is the same as in Comparative Example 1 above. Examples 4 to 8 are examples where plasticizers were incorporated such that the plasticizer component mass ratios were 9, 4, 2.3, 1, and 0, respectively, and the formulation of Example 8 is the same as in Example 2 above. In all of the examples, as compared to Comparative Example 5, excellent effects were exhibited on both the 300% modulus and tear strength. In addition, these excellent effects became more pronounced as the plasticizer component mass ratio approached 0, that is, as the proportion of the sorbitan fatty acid ester incorporated increased.

TABLE 2

| | Comp. | | | | | |
|---|---|---|---|---|---|---|
| | Ex. 5 | Ex. 4 | Ex. 5 | Ex. 6 | Ex. 7 | Ex. 8 |
| Formulation (parts by mass) | | | | | | |
| SBR-1 | 40 | 40 | 40 | 40 | 40 | 40 |
| SBR-2 | 60 | 60 | 60 | 60 | 60 | 60 |
| Silica | 85 | 85 | 85 | 85 | 85 | 85 |
| Carbon black | 5 | 5 | 5 | 5 | 5 | 5 |
| Aromatic oil | 27 | 24.3 | 21.6 | 18.9 | 13.5 | |
| Sorbitan fatty acid ester-4 | | 2.7 | 5.4 | 8.1 | 13.5 | 27 |
| Silane coupling agent | 7 | 7 | 7 | 7 | 7 | 7 |
| Stearic acid | 2 | 2 | 2 | 2 | 2 | 2 |
| Zinc oxide | 2 | 2 | 2 | 2 | 2 | 2 |
| Wax | 2 | 2 | 2 | 2 | 2 | 2 |
| Antioxidant-1 | 2 | 2 | 2 | 2 | 2 | 2 |
| Antioxidant-2 | 1 | 1 | 1 | 1 | 1 | 1 |
| Vulcanizing agent | 2 | 2 | 2 | 2 | 2 | 2 |
| Vulcanization accelerator-1 | 2 | 2 | 2 | 2 | 2 | 2 |
| Vulcanization accelerator-2 | 2 | 2 | 2 | 2 | 2 | 2 |
| Plasticizer Component Mass | — | 9 | 4 | 2.3 | | 0 |
| Ratio | | | | | | |
| Evaluation (index) | | | | | | |
| 300% Modulus | 100 | 101 | 103 | 105 | 108 | 110 |
| Tear strength | 100 | 102 | 103 | 104 | 107 | 109 |

Incidentally, with respect to the various numerical ranges described herein, the upper and lower limits thereof can be arbitrarily combined, and all such combinations are incorporated herein as preferred numerical ranges. In addition, the description of a numerical range “X to Y” means X or more and Y or less.

Although some embodiments of the invention have been described above, these embodiments are presented as examples and not intended to limit the scope of the invention. These embodiments can be implemented in other various modes, and various omissions, substitutions, and changes can be made thereto without departing from the gist of the invention. These embodiments, as well as omissions, substitutions, and changes thereto, etc., fall within the scope and gist of the invention, and also fall within the scope of the claimed invention and its equivalents.

What is claimed is:

1. A rubber composition for a tire, comprising a diene rubber, silica, a sorbitan fatty acid ester, and a mineral oil that is an optional component, wherein
the sorbitan fatty acid ester has an HLB value of 3.5 or more and 5.0 or less, and
a mass ratio of the mineral oil to the sorbitan fatty acid ester is 0 or more and 9 or less.

2. The rubber composition for a tire according to claim 1, wherein the diene rubber includes a modified styrene butadiene rubber.

3. The rubber composition for a tire according to claim 1, wherein 100 parts by mass of the diene rubber includes 20 to 60 parts by mass of an unmodified styrene butadiene rubber and 40 to 80 parts by mass of a modified styrene butadiene rubber.

4. The rubber composition for a tire according to claim 1, wherein the sorbitan fatty acid ester includes at least one selected from the group consisting of sorbitan monooleate, sorbitan monostearate, sorbitan monoisostearate, sorbitan sesquioleate, sorbitan sesquistearate, sorbitan sesquiisostearate, sorbitan dioleate, sorbitan distearate, and sorbitan diisostearate.

5. The rubber composition for a tire according to claim 1, wherein the sorbitan fatty acid ester includes a plant-derived sorbitan fatty acid ester.

6. The rubber composition for a tire according to claim 1, wherein a total content of the sorbitan fatty acid ester and the mineral oil is 10 to 100 parts by mass per 100 parts by mass of the diene rubber.

7. A tire having a rubber portion made using the rubber composition according to claim 1.
